(19) United States
(12) Patent Application Publication
(10) Pub. No.: US 2005/0108387 A1
(43) Pub. Date: May 19, 2005

(54) System and apparatus for a network management system using presence and instant message techniques

(76) Inventors: Bingjun Li, Rohnert Park, CA (US); William X. Huang, San Ramon, CA (US); Liming Gao, Alameda, CA (US); Dong Li, Nanshan (CN)

Correspondence Address: FELIX L. FISCHER, ATTORNEY AT LAW, 1607 MISSION DRIVE, SUITE 204, SOLVANG, CA, 93463, US

(21) Appl. No.: 10/698,675

(22) Filed: Oct. 31, 2003

(51) Int. Cl. G06F 15/173; G06F 15/16

(52) U.S. Cl. 709/224; 709/206

(57) ABSTRACT

A system for network management incorporates Presence and Instant messaging (PIM) techniques. A presence service is used to support the presence discovery of network elements as well as the resources, and services provided by the network elements. An instant messaging service is used for communication between the Element Management System (EMS) and the network elements to support FACPS functionalities. XML is employed as the instant messaging format for the communication between EMS and network elements and adaptors to SNMP, CMIP, and other existing network management protocols are provided. The presence service also allows the presence of NMS, EMS, and SMS to be transparent. Use of buddy group PIM techniques to implement the management relationship between EMS and network elements, and relationship between EMS and NMS is employed. The PIM provides monitoring of servers, network elements, and resources.

### BACKGROUND OF THE INVENTION

1. Field of the Invention

This invention relates generally to the field of telecommunications network management systems and, more particularly, to an element management system (EMS) employing presence and instant messaging (PIM) for communications to the managed network elements in a network and to interact with network management system (NMS) for integrated network management.

2. Description of the Related Art

Management of the network elements in a network is a fundamental requirement for an element management system (EMS). Traditionally, the EMS identifies the presence of network elements within the managed network using a method called “ping”. However, this approach has limitations in that it only provides a single point of polling and does not provide an efficient and systematic method for discovering new network elements or maintaining presence or other status confirmation with a very large number of network elements. It is not efficient compared with peer-to-peer communication in common presence service and instant messaging.

SNMP, CMIP, and CORBA have been used as the major management protocols for communications between EMS and network elements. However the disadvantages of using these management protocols for the communication are very obvious. CMIP is too complicated and very inefficient due to the overhead in the protocol. While it was proposed by the ITU and had been used in some old development in the industry, it is not used in recent development. Because of the weakness of management capability, SNMP is so inefficient to use that even a simple management operation may require several SNMP Protocol operations. Consequently, it is hard to support multi-device operations and atomic operations, particularly grouping of atomic operations.

CORBA has been proposed to make the object level operation easier and is used in some newer network elements with an individual powerful management card. However since the use of CORBA requires a lot of effort in the software development in the management card, it is not popular in the market.

In a traditional network management system, the management relationship between EMS and network elements is implemented based on the network configuration and maintained inside each EMS. It is not easy to provide the global information of this management relationship.

It is therefore desirable to determine the presence of network elements using a simplified mechanism for the EMS and to provide presence knowledge to all network elements.

It is further desirable to establish communication between the EMS and network elements using a simplified communications protocol without significantly increased system hardware and software complexity.

### SUMMARY OF THE INVENTION

The invention as disclosed herein is characterized in two forms: using presence service (PS) and instant messaging (IM) in an EMS and the managed network; and using presence service and instant messaging in a fully integrated network management system.

In an EMS managed network, the element management system (EMS) controls a managed network having a plurality of network elements. A Presence Service and Instant Messaging (PIM) server is interfaced to the EMS and a plurality of PIM clients are operably associated with the network elements. When there is only one EMS server, the PIM engine is located on the same EMS server. The PIM engine also can be on a separate standalone PIM server. The PIM clients are in communication with the PIM engine. The PIM engine and PIM clients provide presence service and instant messaging between the EMS and network elements. The presence service supports the presence discovery of network elements, as well as the resources, and services provided by the network elements. The instant messaging service is used for communication between the Element Management System (EMS) and the network elements to support FCAPS (fault management, configuration management, accounting management, performance management, and security management) functionalities. XML is used as the instant messaging format for communication between the EMS and the network elements. Adaptation to SNMP, CMIP, and other existing network management protocols is provided.

An integrated network management system incorporating the present invention includes a managed network having a plurality of network elements, multiple element management systems (EMS) connected to the managed network and a network management system (NMS) that talks to all the element management systems. An interface is provided for communication between the element management systems (EMS) and a network management system (NMS). A PIM client within the NMS and each EMS allows presence and instant messaging between the management elements, the EMS and NMS as a part of or in conjunction with the interface. The availability monitoring of network/service resource is achieved using the presence and instant messaging service.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of the architecture for an EMS employing a network presence and instant messaging protocol as defined by the present invention;

FIG. 2 is a diagram of interactions during setup and configuration of a network element of the network;

FIG. 3 is a diagram of the logical architecture of an exemplary integrated network management system employing the present invention;

FIG. 4 is a diagram of a physical architecture for the exemplary integrated network management system;

FIG. 5 is a block diagram of structure for an adaptor to conventional protocols; and

FIG. 6 is a diagram of domain-based network management with buddy groups.

### DETAILED DESCRIPTION OF THE INVENTION

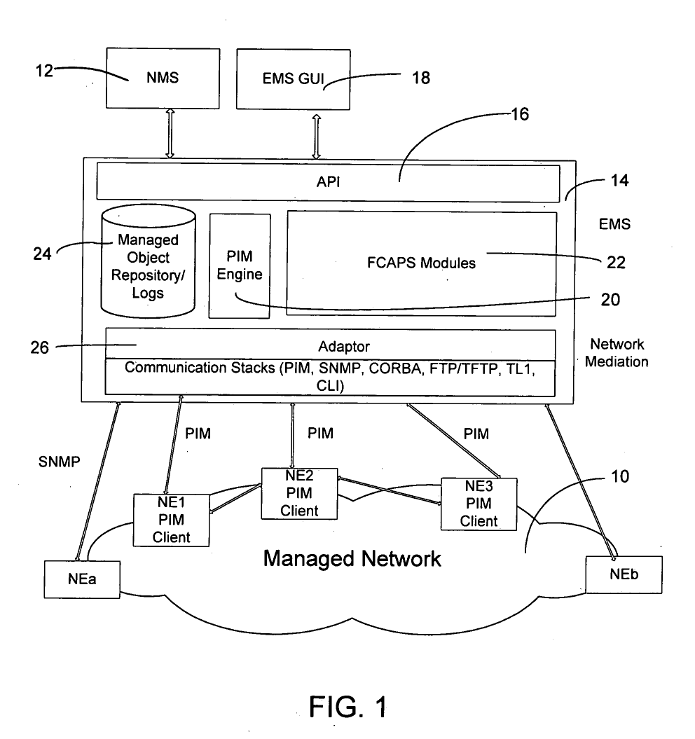

Referring to FIG. 1, the present invention provides a comprehensive framework for communications using presence and instant messaging techniques for a managed network 10. The element management system (EMS) 14 incorporates an Application Programming Interface (API) 16 for communication with the network management system (NMS) 12 and, through an appropriate graphical user interface (GUI) 18, to the operator. The EMS contains a Network Presence and Instant Messaging (PIM) server 20, Fault Management, Configuration Management, Accounting Management, Performance Management and Security Management (FCAPS) modules 22 and a managed object repository 24. The managed object model for the network is an object-oriented design. The containment relationship inside the model is maintained inside the managed object repository. The PIM engine employs a standard based Presence and Instant Message server, such as Expresso IM provided by VirtualThere Inc. which follows the Internet Engineering Task Force (IETF) recommendation RFC2778 “A Model for Presence and Instant Messaging” by M. Day, J. Rosenberg and H. Sugano, and RFC2779 “Instant Messaging/Presence Protocol Requirements” by M. Day, S. Aggarwal, G. Mohr and J. Vincent.

Within the managed network, network elements NE1 to NEk each contain a PIM client. Certain network elements NEa and NEb, as examples, are not provided with an PIM client and are managed in a conventional manner by the EMS. An adapter 26 is provided in the EMS for network mediation through communications stacks which provide PIM capability for the associated PIM equipped network elements and standard SNMP, CORBA, TL1 and CLI communications for non-equipped network elements, FTP/TFTP is used to transfer the large amount of performance data for both PIM equipped and non-equipped network elements.

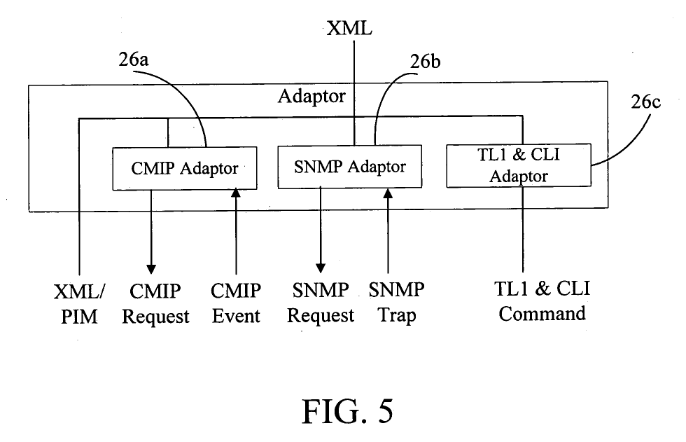

FIG. 5 is a block diagram of structure for adaptor. In this figure, CMIP Adaptor 26a is used to translate the XML-based model to CMIP requests (including M-SET, M-GET, M-ACTION, M-CREATE, M-DELETE) and translate the CMIP Event (-M-EVENT) to the XML-based model. SNMP Adaptor 26b is used to translate the XML-based model to SNMP requests (including SNMP GET-Request, SET-Request, GET-Next) and translate the SNMP Trap to the XML-based model. TL1 & CLI Adaptor is used to translate the XML-based model to TL1 & CLI Commands.

The EMS is configured to know which network elements are PIM equipped or not PIM equipped allowing the EMS to select the appropriate adaptor element to communicate with the managed network elements.

XML is used for the PIM for the embodiments shown. An example of a suitable format is disclosed in the Internet Engineering Task Force (IETF) Internet Draft “Common Presence and Instant Messaging: Message Format” by D. Atkins and G. Klyne. The future XML standard format, that is driven by the IETF NETCONF WG (http://www.ietf.org/html.charters/netconf-charter.html), can be used in alternative embodiments. The drafts include NETCONF Configuration Protocol by R. Enns, BEEP Application Protocol Mapping for NETCONF by E. Lear and K. Crozier, and etc. The adaptor supports the SNMP and CMIP based network elements by adapting the SNMP MIB and CMIP MIB to the XML-based model. Similarly, the EMS employs XML communications to allow flexibility in a northbound interface with NMS, as will be described subsequently with respect to logical architecture and exemplary deployment of systems employing the invention.

For the present invention, the management relationship between the EMS and a network element is maintained as buddy group information. The embodiment of FIG. 1 shows only one EMS and one NMS. However, the PIM system employed by the invention allows architectures with multiple EMS, NMS or Service Management Systems (SMS) involved in the network, as will be described in greater detail subsequently.

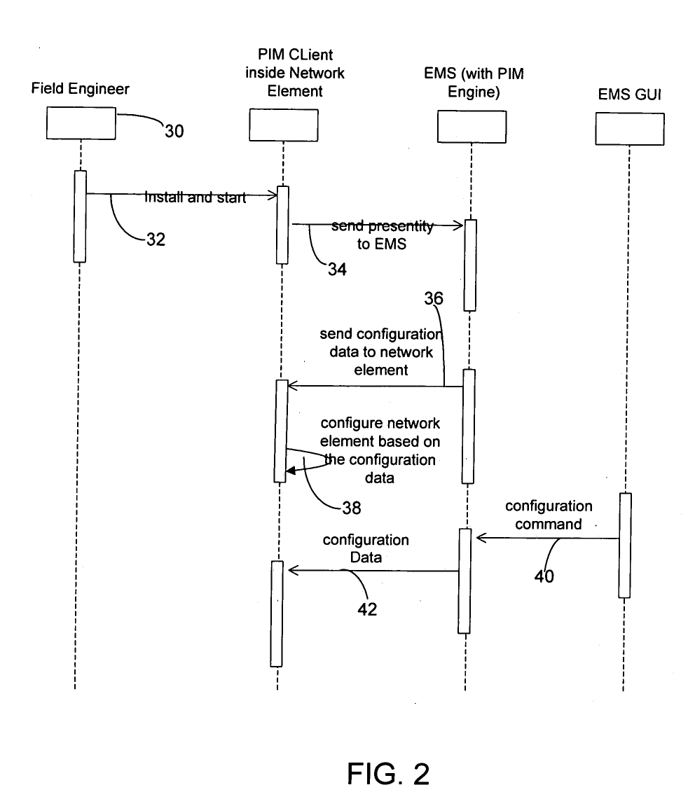

As an example of operation of the invention, the initial configuration of a network element is shown in FIG. 2. The field engineer 30 installs and starts the network element in step 32. The PIM client in the network element sends presentity to the EMS in step 34. The PIM engine in the EMS receives the presence information and sends the configuration data to the network element from the FCAPS configuration module in step 36. The PIM client in the network element receives the configuration data in XML and the configuration management module inside the network element configures the cards and services in the network element accordingly, as shown in step 38.

If the network operator needs to configure services on the network element after the initial configuration, commands are provided through the GUI to the EMS in step 40 that then sends the configuration data to the network element via the instant messaging service in step 42. The object-oriented model in conjunction with the capability of instant messaging allows configuration for multiple managed objects to be altered in one configuration operation. Configuration transaction management is also supported. All the configuration operations on the specified managed objects are included in the same configuration request. Each of the operations should be successful; however, if one of the configuration operations has failed, all the successful configuration operations are rolled-back, and a return “failed” is provided to EMS to indicate that the whole configuration operation is failed. The configuration therefore remains consistent between EMS and network elements. Similarly, if configuration data changes inside a network element, the data is forwarded to the EMS via instant messaging. Synchronization of the configuration data between a network element and the EMS is achieved via the instant messaging service and, with the use of XML, configuration data of multiple managed objects inside the network element or the elements in the whole network are easily synchronized.

Once a new network element containing a PIM client is brought up in the network, as previously described, the presence service notifies the EMS. The topology database is updated in the EMS managed object repository and the NMS is notified through the northbound interface. This allows network/service resource management with reduced complexity. Any resource change is sent to the EMS from the network element via the instant messaging service or as a presence change.

As with configuration data, fault management is simplified using the PIM. Alarms and events can be sent via PIM format. The alarm definitions, including timestamp, alarm type, probable cause, specific problems, etc. are structured in XML. Industrial XML parsers are employed to support the alarm/event processing function once an alarm/event is received by the EMS, for example, IBM XML4J Apache Xerces (http://alphaworks.ibm.com/tech/xml4j), Sun Project X (http://java.sun.com/products/xml/index.html), Oracle XML Parser for Java (http://technet.oracle.com/tech/xml/parser_java2/) and James Clark XP (http://jclark.com/xml/xp/index.html). Standard definition of alarm is formatted for the exemplary embodiment as disclosed in the previously referenced Internet Draft by Atkins and Klyne. The inventive system employing PIM allows more efficient parsing than use of SNMP trap, and minimizes the network usage. However, the present system, as disclosed, allows existing SNMP alarms/events from SNMP-managed network elements by translation through the adaptor in the EMS that converts the alarm/event into the standard XML-based model.

Real time performance monitoring data and accounting information are collected in XML using PIM to transmit the data to the EMS. The data can then be forwarded, again using PIM, to the NMS or an Accounting Manager within the system. Use of PIM for performance data allows an increase in speed over standard communication protocols. For historical performance analysis requiring transfer of large amounts of data is preferably accomplished in the system using FTP/TFTP through the adaptor.

An example of implementation of an alarm using Atkins/Klyne format in a system employing the present invention is shown in Table 1. In this example, network element NE108 sends a ReplaceableUnitMissing alarm to EMS1.

TABLE 1

m: Content-type: Message/CPIM
s:
h: From: NE108 <im:ip172.19.64.108>
h: To: EMS1<im:ip172.19.64.2>
h: DateTime: 2000-12-13T13:40:00-08:00
h: Subject: alarm notification
s:
e: Content-type: text/xml; charset=utf-8
e: <body>
e:<?xml version=“1.0” encoding=“ISO-8859-1”?>
e:<alarm notification>
e: alarm
e: entityType=“Card”
e: entityInstance=“E1Card7”
e: timeStamp=“2000-12-13T13:40:00-08:00”
e: alarmType=“Equipment”
e: probableCause=“ReplaceableUnitMissing”
e: severity=“Critical”
e: additionalText=“E1Card7 is removed.” >
e: </alarm>
e: </alarm notification>
e: </body>

Similarly, an example of performance data collecting using Atkins/Klyne format for a system employing the present invention is shown in Table 2. In this example, EMS1 gets ES, SES from network element NE108.

TABLE 2
The detail information for the performance collecting request is:

m: Content-type: Message/CPIM
s:
h: From: EMS1<im:ip172.19.64.2>
h: To: NE108 <im:ip172.19.64.108>
h: DateTime: 2000-12-13T13:40:00-08:00
h: Subject: performance collecting
s:
e: Content-type: text/xml; charset=utf-8
e: <body>
e:<?xml version=“1.0” encoding=“ISO-8859-1”?>
e:<performance collecting>
e: <interface-name> STM4 </interface-name>
e: <performanceType
e: ES=“”
e: SES=“ “ >
e: </performanceType>
e: </performance collecting>
e: </body>

The detail information for the performance collecting response is:

m: Content-type: Message/CPIM
s:
h: From: NE108 <im:ip172.19.64.108>
h: To: EMS1<im:ip172.19.64.2>
h: DateTime: 2000-12-13T13:40:00-08:00
h: Subject: performance collecting reply
s:
e: Content-type: text/xml; charset=utf-8
e: <body>
e:<?xml version=“1.0” encoding=“ISO-8859-1”?>
e:<performance collecting reply>
e: <interface-name> STM4 </interface-name>
e: <performanceType
e: ES=“40”
e: SES=“ 20” >
e: </performanceType>
e: </performance collecting reply>
e: </body>

Similarly for the security management module, the complex security applications with overall control capability to select and authorize user actions and access to network resources and information is readily accomplished using PIM communication between the network element and the EMS. Verifying access and privileges of network users to ensure legitimate use, confidentiality and data integrity of the network element being accessed can be rapidly accommodated. Use of Internet and web based network management increases the importance of security management. XML is employed for defining the security profiles and the PIM instant messaging service supports the transfer of security check information and acknowledgement between the EMS and a network element.

An example of security management using Atkins/Klyne format for a system employing the present invention is shown in Table 3. In this example, EMS1 sets the security profile for network element NE108 for multiple users and then “user2” attempts to perform a configuration operation on NE108 which is not allowed.

TABLE 3
The detail information for setting security profile is:

m: Content-type: Message/CPIM
s:
h: From: EMS1<im:ip172.19.64.2>
h: To: NE108 <im:ip172.19.64.108>
h: DateTime: 2000-12-13T13:40:00-08:00
h: Subject: set security profile
s:
e: Content-type: text/xml; charset=utf-8
e: <body>
e:<?xml version=“1.0” encoding=“ISO-8859-1”?>
e:<set security profile>
e: <user
e: userName=”user1”
e: password=”abcde”
e: privileges=”configuration; performance; fault; security;” >
e: </user>
e: <user
e: userName=”user2”
e: password=”12345”
e: privileges=”performance; fault;” >
e: </user>
e: </set security profile>
e: </body>

The detail information for performing the attempted configuration operation with by user2 is:

m: Content-type: Message/CPIM
s:
h: From: EMS1<im:ip172.19.64.2>
h: To: NE108 <im:ip172.19.64.108>
h: DateTime: 2000-12-13T13:40:00-08:00
h: Subject: configuration
s:
e: Content-type: text/xml; charset=utf-8
e: <body>
e:<?xml version=“1.0” encoding=“ISO-8859-1”?>
e:<configuration>
e: <interface-name> STM1 </interface-name>
e: <administrativeState> disabled </administrativeState>
e: <accessControl
e: userName=”user2”
e: password=”12345” >
e: </accessControl>
e: </configuration>
e: </body>

Because user2 doesn't have the privilege to do a configuration operation, this operation is rejected by NE108, and the resulting configuration response to EMS1 is:

m: Content-type: Message/CPIM
s:
h: From: NE108 <im:ip172.19.64.108>
h: To: EMS1<im:ip172.19.64.2>
h: DateTime: 2000-12-13T13:40:00-08:00
h: Subject: configuration response
s:
e: Content-type: text/xml; charset=utf-8
e: <body>
e:<?xml version=“1.0” encoding=“ISO-8859-1”?>
e:<configuration response>
e: <interface-name> STM1 </interface-name>
e: <administrativeState> disabled </administrativeState>
e: <operationResult>failed</operationResult>
e: </configuration response>
e: </body>

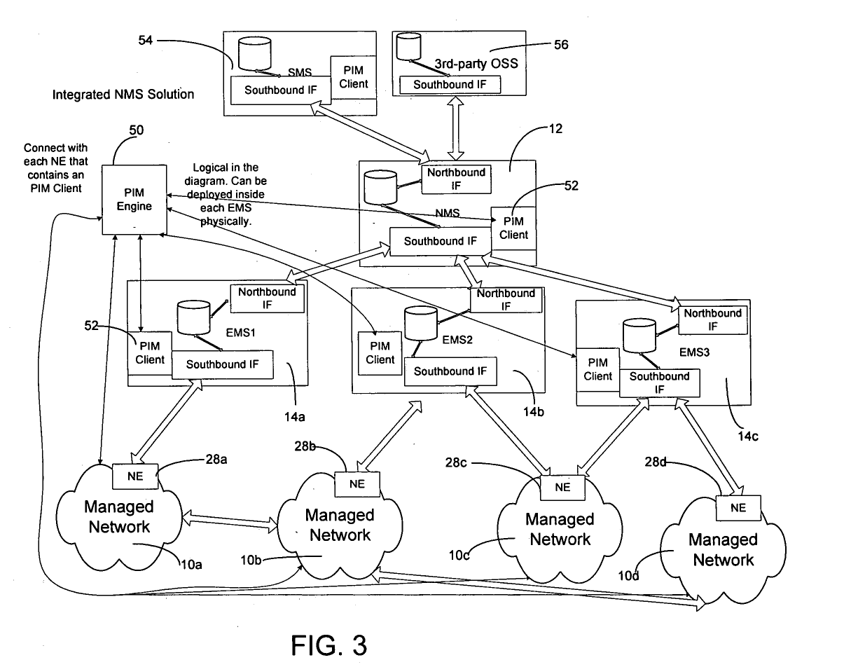

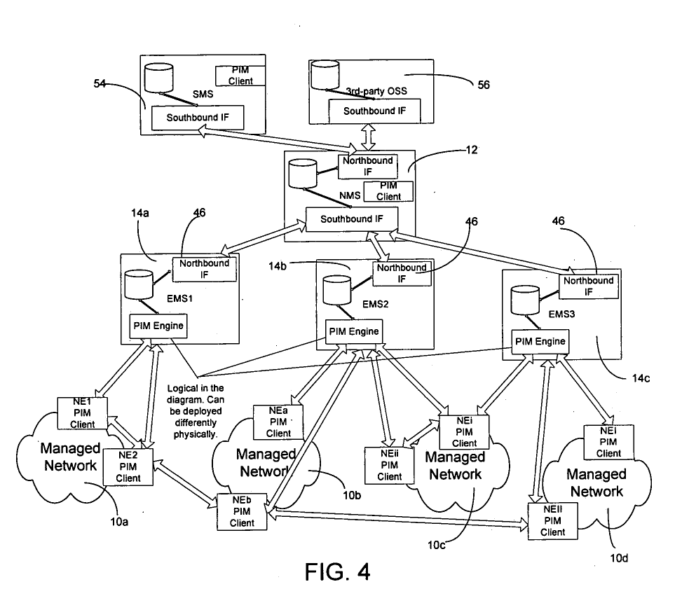

FIG. 3 demonstrates a logical architecture for an integrated network management system using PIM pursuant to the present invention. The logical PIM engine 50 is connected with each network element within the managed networks 10a, 10b, 10c and 10d containing a PIM client. This logical arrangement can be physically deployed in a large network by placing a PIM engine in each of the EMS/NMS servers in the network. In a small network, the PIM engine may be deployed in the NMS server. Each management system whether an EMS, a NMS or a SMS contains a logical PIM client 52. Typical physical deployment is described subsequently with respect to FIG. 4.

The manager-to-manager relationship for an exemplary embodiment is maintained as buddy group information. Normally each EMS 14a, 14b, 14c is managed by one NMS 12 and belongs to one buddy group. However, an EMS may also provide integration to a second NMS (or 3rd-party NMS). This management relationship allows the health monitoring of the EMS and provides support for EMS recovery.

The management relationship between EMS and a network element is also maintained as buddy group information for an exemplary embodiment. Normally one network element, for example NE 28a in network 10a, is managed by one EMS 14a and belongs to one buddy group. However in some special situations, one network element, for example NE 28c in network 10c, may be managed by more than one EMS 14b and 14c and belong to multiple buddy groups.

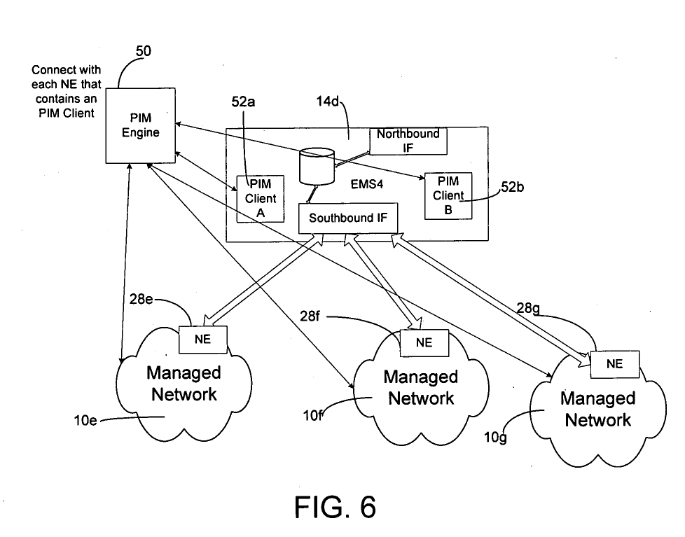

Physical domain-based (location-based) network management can be achieved employing the present invention through buddy groups and multiple PIM clients. For example, in FIG. 6, network 10e, 10f and 10g are managed by EMS 14d, and according to the operator's management point of view, network 10e and network 10f belong to domain a, but network 10g belongs to domain b. Two buddy groups are created: buddy group a for domain a and buddy group b for domain b. In this case, two PIM clients are provided in EMS 14d: PIM client 52a for buddy group a and PIM client 52b for buddy group b. PIM Client A corresponds to operator A while PIM Client B corresponds to operator B. Similarly, a system employing the present invention are alternatively configured for multiple operators (multiple PIM Clients) for the same managed domains.

Logical domain-based buddy groups are created in alternative embodiments for network management. For example, buddy groups are created according to management functions: one buddy group for fault management, one buddy group for performance management and one buddy group for configuration management. In this case, at least one PIM client that represents one operator is provided in the EMS for each buddy group.

For a big network, EMS, NMS, and SMS may be deployed on different machines. If each system's security is standalone, a user must login to different systems separately to access the network management functionalities of interest. To build a fully integrated network management system and support customer network management requirements, security management must be integrated. An exemplary approach is to integrate all the security management into one centralized security database (DB). This centralized security database can be located on any machine that other EMS, NMS and SMS can access (for example, in the NMS server). The security data is centralized. The centralized security server (including DB) and the API to access the security servers are known in the art.

In alternative embodiments, the security data is fully distributed. Each EMS contains only the security data belonging to the users of the network supported by the EMS. A centralized security DB, which is the superset of all the security data for the entire network, is incorporated in the Security Server to provide for convenient administration. The PIM engines and clients among the EMS/NMS/SMS servers provide a convenient way of user security profile synchronization through presentity format and protocol.

For all management systems (EMS and NMS), the northbound interface 46 is based on XML. Since the object-oriented managed object model can be described in XML, using XML for the northbound interface makes the model transparent. An example demonstrating this transparency is shown in Table 4 for an alarm using Atkins/Klyne format in the EMS1 northbound interface. In this example, EMS1 sends two alarms (ReplaceableUnitMissing and LOS) raised in network element NE108 to NMS.

TABLE 4
The detail information is:

m: Content-type: Message/CPIM
s:
h: From: EMS1<im:ip172.19.64.2>
h: To: NMS<im:ip172.19.64.6>
h: DateTime: 2000-12-13T13:40:00-08:00
h: Subject: alarm notification
s:
e: Content-type: text/xml; charset=utf-8
e: <body>
e:<?xml version=“1.0” encoding=“ISO-8859-1”?>
e:<alarm notification>
e: <alarm
e: ne=“NE108”
e: entityType=“Card”
e: entityInstance=“E1Card7”
e: timeStamp=“2000-12-13T13:40:00-08:00”
e: alarmType=“Equipment”
e: probableCause=“ReplaceableUnitMissing”
e: severity=“Critical”
e: additionalText=“E1Card7 is removed.” >
e: </alarm>
e: <alarm
e: ne=“NE108”
e: entityType=“Interface”
e: entityInstance=“STM4”
e: timeStamp=“2000-12-13T13:40:00-08:00”
e: alarmType=“Communications”
e: probableCause=“LOS”
e: severity=“Critical”
e: additionalText=“LOS is raised.” >
e: </alarm>
e: </alarm notification>
e: </body>

An exemplary physical architecture of the invention is shown in FIG. 4 corresponding to the logical architecture previously described. The managed networks, 10a, 10b, 10c and 10d, each contain many network elements as exemplified by NE1 and NE2 in network 10a, NEa and Neb in network 10b, NEI and NEII in network 10c and NEi and NEii in network 10d. Three EMS, 14a, 14b and 14c supervise the network elements. Note that, as previously described, network element NEi is managed by both EMS 14b and EMS 14c. Each EMS contains a PIM engine while each network element and the NMS 12 and SMS 54 contain PIM clients. The PIM is used to provide hierarchical end-to-end network management. Each management system, SMS/NMS/EMS, provides presence information through PIM. Each network element through its respective PIM client provides presence information. Topology management is accommodated by recording of the presence information. Each network element added provides presentity through the PIM and the topology database of the managed object repository in the EMS are updated. Notification to the NMS is accomplished through instant messaging through the northbound interface of the EMS and similarly the SMS and any 3^{rd} party OSS 56 are notified through the northbound interface of the NMS.

As an example of a wireless network employing the present invention in operation, status of the base station as a network element would be available to the EMS/NMS by presentity. If the base station were lost due to malfunction, whether through power failure or other cause, the change in presentity status to “out of contact” through the presence service of the PIM would immediately notify the EMS of the failure. Notification of a responsible operator is then accomplished using instant messaging employing the alarm/event protocols previously described. Dispatch of a field engineer or alternative resolution can then be immediately commenced by the operator. Upon restoring the base station to operation, presentity would again be made by the base station through the PIM and appropriate instant messaging for system update by the EMS/NMS would then be accommodated.

Having now described the invention in detail as required by the patent statutes, those skilled in the art will recognize modifications and substitutions to the specific embodiments disclosed herein. Such modifications are within the scope and intent of the present invention as defined in the following claims.

1. A system for network management comprising:
a plurality of network elements;
an element management system (EMS) connected to the plurality of network elements;
a Presence and Instant Messaging (PIM) engine interfaced to the EMS and a plurality of PIM clients operably associated with the network elements, the PIM clients in logical communication with the PIM engine, the PIM engine and PIM clients providing presence service and instant messaging between the EMS and network elements; and,
northbound interface means for communication between the EMS and a network management system (NMS).

2. A system for network management as defined in claim 1 further comprising a PIM client operably associated with the NMS for presence service and instant messaging.

3. A system for network management as defined in claim 1 wherein the EMS further incorporates an adaptor for network mediation having communication stacks to accommodate PIM presence service and instant message traffic between the PIM clients and the PIM engine and to further accommodate at least one alternative standard communication protocol.

4. A system for network management as defined in claim 3 wherein the at least one alternative communication protocol is selected from the set of SNMP, CORBA, FTP/TFTP, TL1 and CLI.

5. A system for network management as defined in claim 3 wherein the managed network includes a second plurality of network elements, said second plurality of network elements communicating through the adaptor using the at least one alternative standard communication protocol.

6. A system for network management as defined in claim 1 wherein the EMS further incorporates a managed object repository for storing presentity of the plurality of network elements provided through the PIM presence service.

7. A system for network management as defined in claim 1 wherein the PIM employs XML format.

8. A system for network management as defined in claim 1 wherein the EMS further includes fault management, configuration management, accounting management, performance management and security management (FCAPS) modules, said modules adapted for communication through the PIM.

9. A system for network management as defined in claim 1 wherein the EMS further includes means for operator interface.

10. A system for network management as defined in claim 9 wherein the operator interface means comprises a Graphical User Interface (GUI).

11. A fully integrated network management system comprising:
a plurality of network elements;
at least one element management system (EMS) connected to the plurality of network elements;
a network management system (NMS) connected through a northbound interface from the EMS;
a Service Management System (SMS) connected through a northbound interface from the NMS;
a Presence and Instant Messaging (PIM) engine interfaced to the EMS and a plurality of PIM clients operably associated with the network elements, the EMS, the NMS and the SMS, the PIM clients in logical communication with the PIM engine, the PIM engine and PIM clients providing presence service and instant messaging between the EMS, NMS, SMS and network elements.

12. A method for management of a network with a plurality of network elements employing a network management system (NMS) and at least one element management system (EMS) comprising the steps of:
providing a Network Presence and Instant Messaging (PIM) engine;
providing a plurality of PIM clients associated with each of the plurality of network elements and the EMS;
communicating presence of any element of the network by presentity through the PIM engine and clients;
maintaining a data base of presentity in the EMS; and,
communicating between the EMS and network elements by instant messaging through the PIM engine and clients.

13. A method for management of a network as defined in claim 12 further comprising the steps of:
providing a PIM client associated with the NMS;
communicating presence of the NMS and EMS by presentity through the PIM engine and clients; and
communicating between the EMS and NMS by instant messaging through the PIM engine and clients.

15. A method for management of a network as defined in claim 12 wherein the EMS includes fault management, configuration management, accounting management performance management and security management (FCAPS) modules and wherein the step of communicating between the EMS and network elements includes the step of:
communicating fault management, configuration management, accounting management, performance management and security management data by presence service and instant messaging.

16. A method for management of a network as defined in claim 12 wherein a Service Management System (SMS) is incorporated in the network and further comprising the steps of
providing a PIM client associated with the SMS;
communicating presence of the SMS by presentity through the PIM engine and clients; and
communicating between the EMS, NMS and SMS by instant messaging through the PIM engine and clients.

17. A method for management of a network as defined in claim 16 further comprising the step of maintaining a management relationship among the SMS, NMS, and EMS using a buddy group.

18. A method for management of a network as defined in claim 16 wherein the network includes a security server and further wherein the steps of:
communicating presence further comprises including security profile information; and
communicating between the network elements, EMS, NMS and SMS by instant messaging through the PIM engine and clients further comprises limiting communication response based on the security profile.

19. A method for management of a network as defined in claim 16 further comprising the step of monitoring the availability of network/service resources using the presence and instant messaging service.

20. A method for management of a network as defined in claim 16 further comprising the step of including all related operators as PIM clients together with the managed network elements and NMS/EMS components in a buddy group to support domain-based network management.
